(19) United States
(12) Patent Application Publication
(10) Pub. No.: US 2009/0018710 A1
(43) Pub. Date: Jan. 15, 2009

(54) DEVICE FOR CONTROLLING EQUIPMENT

(75) Inventors: Patrick Marey, Fontenilles (FR); Pierre-Numa Lavigne, Toulouse (FR); Alain Locatelli, Tournefeuille (FR); Dominique Garel, Saint-Orens (FR)

Correspondence Address: PERMAN & GREEN, 425 POST ROAD, FAIRFIELD, CT, 06824, US

(73) Assignee: AIRBUS FRANCE, Toulouse Cedex 9 (FR)

(21) Appl. No.: 12/088,307

(22) PCT Filed: Sep. 27, 2006
(86) PCT No.: PCT/FR2006/050947

§ 371 Date: Sep. 4, 2008

(30) Foreign Application Priority Data
Sep. 30, 2005 (FR) 0552962

(51) Int. Cl. G06F 17/00

(52) U.S. Cl. 701/1

(57) ABSTRACT

The disclosed embodiments concerns a device and method for controlling equipment having a plurality of subassemblies and provided with a storage unit storing at least one set of information relating to the subassemblies, a connection being used for extracting the set of coded information.

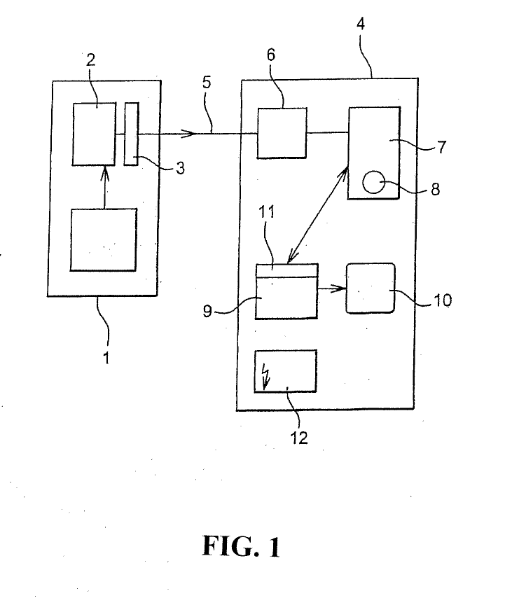

According to the disclosed embodiments, the set of information received by means of the connection is recorded in a first file on a recording medium, and then, from at least a second file previously recorded on the recording medium, the characteristics of the coding are determined in order to identify this information. The content of the first file is analysed using the characteristics, and the result thus obtained is recorded in a third file on the recording medium.

### CROSS-REFERENCE TO RELATED APPLICATIONS

This application is the National Stage of International Application No. PCT/FR2006/050947, International Filing Date, 2006-09-27, which designated the United States of America, and which international application was published under PCT Article 21(2) as WO Publication No. WO 2007/036674 A2 and which claims priority from French Application No. 0552962, filed 2005-09-30, the disclosures of which are incorporated herein by reference in their entirety.

### BACKGROUND

1. Field

The disclosed embodiments concern a device and method for controlling equipment, in particular for equipment on board an aircraft.

More precisely, the disclosed embodiments apply to equipment comprising a plurality of subassemblies, in particular hardware and software, and which is provided with a storage unit storing at least one set of information relating to these subassemblies.

2. Brief Description of Related Developments

Such equipment on board aircraft is known, which is onboard computers, for example, such as the flight control computer, the aerodynamic data computer, etc. These computers are capable of storing a certain number of events relating to this equipment, such as faults, states, etc. During maintenance procedures on the aircraft or the said equipment, an operator must examine the data stored by each computer in a storage unit in order to verify the state of this equipment so as to determine whether it must be repaired or improved.

To do this, the operator uses a tool responsible for recovering all the data stored by the computer on this storage unit. These data are formulated specifically for each computer according to a code produced by the manufacturer. Consequently the recovery of the said data stored in the various computers is carried out heterogeneously according to the various computers, requiring for this tools specific to each computer.

The phases of maintenance of an aircraft or equipment on this aircraft may therefore prove to be lengthy and expensive, several specialist operators being where appropriate necessary for operating a plurality of tools each dedicated to an item of equipment.

### SUMMARY

The aim of the disclosed embodiments is to remedy these drawbacks. to the aspects of the disclosed embodiments propose a device and method for controlling equipment, during maintenance or when it is faulty, simple in their design and in their operating mode, economical, and allowing control of a plurality of items of equipment employing different data codings, by configuration of this device so as to adapt it to each new item of equipment controlled. There is thus available a universal equipment control device.

For this purpose, the disclosed embodiments concern a method of controlling equipment comprising a plurality of subassemblies and provided with a storage unit storing at least one set of information relating to the subassemblies, a connection being implemented in order to extract this set of information, this information being coded.

According the disclosed embodiments, this method comprises the following steps:

the set of information received by means of the connection is recorded in a first file on a recording medium,

from at least a second file previously recorded on the recording medium, the characteristics of the coding are determined in order to identify this information,

the content of the first file is analysed using the said characteristics of the coding, and

the result thus obtained is recorded in a third file on the recording medium.

“Controlling” in the expression “device and method for controlling equipment” means an aid to the maintenance of this equipment by virtue of the examination of the data stored in this equipment.

In various particular embodiments of this control method, each having its particular advantages and open to numerous possible technical combinations;

step c) comprises the following steps:

c₁) the data are deformatted,

c₂) the deformatted data are identified,

c₃) the data thus identified are decoded;

a decompressor is used at step c₁) in order to decompress the data,

step c₁) comprises a step of de-encapsulation of the data.

“De-encapsulation” means in particular the removal of the data specific to the coding such as the security data (CRC, etc).

the connection is intended to transmit signals of the serial type. Advantageously, the connection is an asynchronous serial connection of the RS 232 type or RS 422 type.

the connection is intended to transmit signals of the radio or optical type.

By way of illustration, a converter can be used for converting a signal of the serial type into a signal intended to be transported by a monomode or multimode optical fibre cable, which makes it possible both to transport data over a greater distance within an aircraft, for example from the equipment to the cockpit, and to ensure immunity from electrical interference. Alternatively, it may be a case of a cabled connection of the Ethernet type.

The disclosed embodiments also concern an equipment control device for implementing the method as described above. This equipment comprises subassemblies and is provided with a storage unit storing at least one set of coded information relating to these subassemblies.

According to the disclosed embodiments, the device comprises:

a means for establishing a connection between the control device and the storage unit,

a recording means for recording in a first file on a recording medium at least one set of information relating to these subassemblies, the said recording medium comprising a set of previously recorded files,

a processing unit for analysing the content of the first file using at least one previously recorded file.

### BRIEF DESCRIPTION OF THE DRAWINGS

The disclosed embodiments will be described in more detail with reference to the accompanying single FIGURE, which depicts schematically an equipment control device according to a particular embodiment of the disclosed embodiments.

The equipment control method of the disclosed embodiments is particularly adapted to the control of equipment comprising a plurality of subassemblies (hardware and/or software).

This equipment is also provided with a storage unit storing at least one set of information relating to the subassemblies. This storage unit is preferably a non-volatile memory.

A connection is used to extract the set of information from the storage unit to the control device, this information being coded.

### DETAILED DESCRIPTION OF THE EMBODIMENTS

In a first step of the method of the disclosed embodiments, this set of information, received by means of this connection, is recorded in a first file. The latter is stored on a recording medium.

According to a second step, the characteristics of the coding are determined from at least a second file in order to identify this information.

This second file is previously recorded on the recording medium. For this purpose, the device for using this method that comprises the recording medium also comprises means for remotely loading the recording medium with configuration files.

This second file is in fact a configuration file that comprises at least one coding library for decoding the set of coded information.

Advantageously, references of this equipment are sent at the same time as the said first step of extracting the set of information stored on the storage unit to the recording medium in order to allow the determination of this second file. These references comprise for example the number defining the identity of this equipment (PN—“Part Number”).

Then the content of the first file is analysed using the characteristics of the coding supplied by the said at least second file.

For this purpose, when the set of information has previously been compressed by a compressor before its transmission from the storage unit to the control device, a decompressor is used for reconstructing the set of information from the data recorded in the first file.

The data decompression algorithm used depends on the compression algorithm used for compressing the data on the storage unit. This decompression algorithm can be a lossless decompression algorithm of the RLE or GZIP type, or the Lempel-Ziv decompression algorithm.

The information thus decompressed is then the subject of de-encapsulation and then the result that is obtained is recorded in a deformatted file. The data to be de-encapsulated are defined by the said at least second file.

The deformatting of the data therefore consists of a data de-encapsulation step and possibly a prior step of decompression.

After deformatting of the data, the deformatted data recorded in the deformatted filed are identified. This data identification step consists of determining the type of information processed, for example that this information relates to a flight phase, the subassembly of equipment from which this information comes, etc.

After decoding of the data thus identified using the code supplied by the said at least second file, the result thus obtained is recorded in a third file on the recording medium. When the first file does not require deformatting, the content of the first file is analysed directly by using the code supplied by the said at least second file.

Preferably the data of the third file are next displayed on display means.

For this purpose, it is advantageously possible to use a presentation file previously recorded on the recording medium to define the display of the data of the third file. It is a case of presenting the data of this third file in a report that can be read by the operator controlling the equipment.

The display means can allow the editing of a document comprising a text file or a table. It may also be a case of a display screen for displaying a table or text.

Alternatively, the data of the third file can be used to produce statistics. By way of example, it is possible to connect the device 4 to an external processing unit in order to carry out an analysis of the faults on various items of equipment.

The single FIGURE shows an equipment control device according to a particular embodiment of the disclosed embodiments. This equipment 1 comprises a plurality of subassemblies and is provided with a storage unit 2. The storage unit 2 is preferably a non-volatile memory.

The control device 4 comprises a means 5 for establishing a connection between the control device 4 and the storage unit 2. This means 5 for establishing a connection is preferably chosen from the group comprising an asynchronous serial link of the RS 232 type or RS 422 type, an Ethernet cabled connection, or an electromagnetic wave emitter placed on the equipment 1 and able to cooperate with a receiver arranged on the control device 4.

Before transmission of the data from the storage unit 2 to the control device 4 by means of the connection 5, the data are advantageously compressed by a data compressor 3 in order to take account of the volume of data to be transmitted and thus reduce the transfer time. A data compression algorithm is then used. The latter is advantageously a lossless compression algorithm.

The control device 4 then may be able to store, on a recording medium, the set of information received by means of the connection 5 and to retrieve this set subsequently by connecting this device 4 to an external processing unit. Nevertheless it is itself able to process this set of information.

For this purpose, the control device 4 comprises a recording means 6 for recording at least one set of information relating to the subsets in a first file on a recording medium 7. This recording medium 7 also comprises a set of previously recorded files 8. These files 8 comprise coding libraries for decoding the set of coded information. These coding libraries can be in the form of tables or coding matrices. These files 8 are also used during the analysis step for defining the data to be de-encapsulated and for identifying the data after the deformatting step. Finally, they are used for determining in particular the number of data to be presented.

The control device 4 comprises a processing unit 9 for analysing the content of the first file using at least one of the previously recorded files 8. The device preferably comprises means for remotely loading the recording medium 7 with configuration files. It is thus possible to increase the number of previously recorded files and thus to continuously adapt the control device.

The result of the analysis carried out by the processing unit 9 can be displayed on display means 10.

The device can comprise a decompressor 11 for reconstructing the set of information when the latter was compressed before transmission thereof from the storage unit 2 of the equipment 1 to the control device 4.

It may also comprise a supply source 12 for supplying the storage unit 2 with energy when the equipment 1 is not powered up. This supply source 12 comprises for example at least one cell or battery, rechargeable or not. The operator can selectively supply or not the storage unit 2 with this supply source 12 according to the state of the equipment 1, that is to say whether or not the latter is powered up.

1. A method of controlling equipment comprising a plurality of subassemblies and provided with a storage unit storing at least one set of information relating to the said subassemblies, a connection being used for extracting the said set of information, the said information being coded, the method comprising:
a) the set of information received by means of the said connection is recorded in a first file on a recording medium,
b) from at least a second file previously recorded on the recording medium, the characteristics of the coding are determined in order to identify this information,
c) the content of the first file is analysed using the said characteristics of the coding, and
d) the result thus obtained is recorded in a third file on the recording medium.

2. A method according to claim 1, wherein step c):
c₁) the data are deformatted,
c₂) the deformatted data are identified,
c₃) the data thus identified are decoded.

3. A method according to claim 2, characterised in that, at step c₁), a decompressor is used for decompressing the data.

4. A method according to claim 2, wherein step c₁) comprises a data de-encapsulation step.

5. A method according to claim 1, further comprising, during the step of extracting the said set of information stored on the said storage unit to the said recording medium, references of the said equipment for determining the said at least second file are sent.

6. A method according to claim 1, further comprising that the data of the third file are displayed on display means.

7. A method according to claim 6, characterised in that a presentation file previously recorded on the said recording medium is used to define the display of the data of the said third file.

8. A method according to claim 1, further comprising that the connection is configured to transmit signals of the serial type.

9. A method according to claim 1, further comprising that the connection is configured to transmit signals of the radio or optical type.

10. Equipment control device for implementing the method specified according to claim 1, the equipment comprising subassemblies and being provided with a storage unit storing at least a set of coded information relating to the said subassemblies, the equipment further comprising:
a means for establishing a connection between the control device and the storage unit,
a recording means for recording in a first file on a recording medium the set of information relating to these subassemblies, the recording medium comprising a set of previously recorded files,
a processing unit for analysing the content of the first file using at least one of the previously recorded files.

11. A device according to claim 10, further comprising means for remotely loading the recording medium with configuration files.

12. A device according to claim 10, further comprising a source for supplying the storage unit of the said equipment.

13. A device according to claim 10, further comprising a decompressor for reconstructing the set of information.
